(19) United States
(12) Patent Application Publication
(10) Pub. No.: US 2023/0411721 A1
(43) Pub. Date: Dec. 21, 2023

(54) PROCESS FOR RECOVERY OF METALS AND CARBON POWDER FROM SPENT LITHIUM ION BATTERIES

(71) Applicant: HYDROMET TECHNOLOGY SOLUTIONS PRIVATE LIMITED, Vadodara (IN)

(72) Inventors: Navin MITTAL, Vadodara (IN); Shashi ANAND, Bhubaneshwar (IN); Lakshmi VAIDEESWARAN, Chennai (IN)

(21) Appl. No.: 18/035,732

(22) PCT Filed: Oct. 30, 2021
(86) PCT No.: PCT/IN2021/051043

§ 371 Date: May 5, 2023

(30) Foreign Application Priority Data
Nov. 13, 2020 (IN) 202021049754

(51) Int. Cl. H01M 10/54; C22B 1/02; C22B 3/26; C22B 3/00; C22B 26/12; C22B 47/00; C22B 21/00; C25C 1/08; C25C 1/12; C22B 15/00

(52) U.S. Cl. CPC H01M 10/54; C22B 1/02; C22B 3/26; C22B 23/043; C22B 23/0461; C22B 26/12; C22B 47/00; C22B 21/0023; C25C 1/08; C25C 1/12; C22B 15/0071; H01M 10/0525

(57) ABSTRACT

A process for treating spent lithium ion batteries to recover metals is disclosed. The process includes discharging the spent lithium ion batteries. The discharged lithium ion batteries are shredded and roasted in a furnace to produce roasted material. The roasted material is sieved to separate a coarser fraction and a finer fraction. The coarser fraction comprises aluminium chips and copper chips. The finer fraction is further treated to recover copper, cobalt, and nickel sequentially with a purity of 99.3-99.9%. The process also recovers manganese as manganese dioxide and lithium as lithium carbonate. The process does not generate any solid waste as all the metals and by-products such as carbon powder and gypsum cake are saleable.

### TECHNICAL FIELD

The present disclosure relates to recovery of metals and carbon powder, and particularly relates to recovery of metals and carbon powder from spent lithium ion batteries.

### BACKGROUND OF THE DISCLOSURE

The importance of lithium ion batteries is increasing day by day as these are being used in mobiles, laptops, and other household electronic goods. High-power lithium batteries are used for military applications, aerospace, and electric vehicles. Currently, rechargeable lithium-ion batteries (LIBs) are the batteries of choice in the consumer electronics market due to their favourable characteristics which include, high energy density, long life cycles, low self-discharge, and safe handling. The consumption of lithium ion batteries is constantly expanding resulting in generation of spent or waste Li ion batteries. There are several types of lithium ion batteries such as Lithium Cobalt Oxide (LCO) batteries, Nickel Manganese Cobalt Oxide (NMC) batteries, or Nickel Cobalt Aluminium oxide batteries (NCA). The metals that can be recovered and reused may be copper, nickel, cobalt, lithium, manganese, and aluminium.

In general, spent lithium ion batteries contain copper, lithium, cobalt, nickel, manganese, aluminium in various proportions. The recycling processes for spent lithium ion batteries are driven by the revenues that may be obtained from cobalt recovery due to the high price of cobalt. Lithium extraction from spent batteries is also important due to low availability of raw materials containing lithium and its high demand for electric vehicles. The challenge is to recycle Li-ion batteries with differing cathode chemistries. Processing of spent lithium batteries having a major component of LiCoO₂ is relatively simple because there are few elements present as compared to electric vehicle lithium ion batteries. Several processes based on pyro or pyro-hydrometallurgy have been developed to extract the desired metal values from spent lithium ion batteries. However, some processes are specific for recovery of nickel and cobalt whereas some of the processes are specific for cobalt or cobalt-lithium recovery. Further, a versatile complete process for treating different types of spent lithium ion batteries with varying metals and their compositions has not been reported. A few processes are based on recovering nickel and cobalt as steel alloys by charging the battery material in an electric furnace already charged with steel or by obtaining a metal rich slurry separated from pre-treatment of spent batteries and then charged to an electric smelter. In these processes, lithium remains in the flux. Therefore, there is a need for a process treating different types of spent lithium ion batteries

### SUMMARY OF THE DISCLOSURE

A process for treating spent lithium ion batteries to recover metals is disclosed. In one embodiment, the process includes discharging the spent lithium ion batteries. The discharged lithium ion batteries are shredded and roasted in a furnace to produce roasted material. The roasted material is sieved to separate a coarser fraction and a finer fraction. The coarser fraction comprises aluminium chips and copper chips. The finer fraction is made into a slurry with de-ionized water. The slurry is leached with sulphuric acid and sulphur dioxide under controlled conditions of pH and Eh and then filtered to separate carbon powder from leach liquor. The leach liquor is neutralized with hydrated lime to produce a gypsum cake. The neutralized leach liquor is filtered to separate the gypsum cake from a first filtrate. The first filtrate is subjected to solvent extraction and electrowinning to obtain copper as a copper cathode and to obtain a first raffinate. The first raffinate is treated with hydrated lime to obtain aluminium and to produce a second filtrate. The second filtrate is subjected to solvent extraction and electrowinning to obtain cobalt as a cobalt cathode, manganese as an anode mud and a second raffinate. The second raffinate is subjected to solvent extraction and electrowinning to obtain nickel as a nickel cathode and a third raffinate. The third raffinate is treated with sodium carbonate to recover lithium as lithium carbonate. Thus, the process recovers the metals sequentially as cathodes first recovering copper, then cobalt, and finally nickel as pure cathode while lithium is recovered as lithium carbonate. The process also recovers manganese oxide as anode mud during electrowinning of cobalt. The process is a zero-solid waste producing process, where all the metals and by-product such as carbon powder gypsum cakes are also marketable.

### BRIEF DESCRIPTION OF DRAWINGS

The disclosed process will be described and explained with additional specificity and detail with the accompanying figures in which:

FIG. 1 is a schematic representation of a flowsheet of a process for treating spent lithium ion batteries to recover metals, according to an embodiment of the disclosure.

Further, persons skilled in the art to which this disclosure belongs will appreciate that elements in the figures are illustrated for simplicity and may not have necessarily been drawn to scale. Furthermore, in terms of the construction of the device, one or more components of the device may have been represented in the figures by conventional symbols, and the FIGURES may show only those specific details that are pertinent to understanding the embodiments of the present disclosure so as not to obscure the FIGURES with details that will be readily apparent to those of ordinary skill in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

It will be understood by those skilled in the art that the foregoing general description and the following detailed description are exemplary and explanatory of the disclosure and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or a method. Similarly, one or more devices or sub-systems or elements or structures or components preceded by “comprises . . . a” does not, without more constraints, preclude the existence of other devices, other sub-systems, other elements, other structures, other components, additional devices, additional sub-systems, additional elements, additional structures, or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying FIGURE.

The disclosed process may be achieved by the following specific process steps: discharging the spent lithium ion batteries; shredding; pyro treatment; sieving to obtain a coarser fraction and a finer fraction; manual separation of copper and aluminium from coarser fraction; single stage leaching of the finer fraction, a black powder, using a combination of dilute sulphuric acid and sulphur dioxide; acid neutralization and pH adjustment by hydrated lime slurry in the presence of hydrogen peroxide; copper recovery as cathode by solvent extraction-electrowinning from filtrate 1 obtained after separating gypsum cake by filtration; precipitation of aluminium hydroxide from raffinate 1 (obtained after copper loading from filtrate 1) by pH adjustment followed by filtration to obtain iron, copper and aluminium free filtrate 2; solvent extraction and electrowinning to recover cobalt as cathode and manganese as anode mud using filtrate 2; raffinate 2 after cobalt loading is taken for nickel recovery as nickel cathode by solvent extraction and electrowinning; lithium recovery as lithium carbonate from raffinate 3 (obtained after Ni loading).

“Spent lithium ion batteries” may refer to any type of batteries generated from their use in mobile, laptop or electric vehicles or any other device. The present process is applicable to a wide range of spent lithium ion batteries and varying compositions of Co, Ni, Mn, Li, Al and carbon. All types of lithium ion batteries, including Lithium Cobalt Oxide (LCO) batteries, Nickel Manganese Cobalt Oxide (NMC) batteries, or Nickel Cobalt Aluminium oxide batteries (NCA) or a mixture of spent lithium ion batteries from various sources such as mobiles, laptops and electric vehicles may be used as a feed to the process.

According to an embodiment of the disclosure, the spent lithium ion batteries are dismantled, discharged, and shredded followed by treating in a furnace to obtain copper and aluminium chips in the coarser fraction after one deck screening. The finer fraction obtained after screening is subjected to a single stage leaching followed by sequential extraction of copper, nickel, cobalt, manganese, lithium, and a graphite residue. The process, a pyro and hydrometallurgical process, is a process that utilizes spent lithium ion batteries for producing high purity copper, cobalt and nickel cathodes, lithium carbonate, and manganese dioxide. Roasted material after pyro treatment is subjected to sieving to separate a black powder (a finer fraction) from metallic copper and aluminium (a coarser fraction). The black powder includes cobalt, nickel, manganese, lithium and a small amount of copper and aluminium. The black powder is subjected to hydrometallurgical processing in a single stage leaching followed by purification to remove iron and aluminium. Graphite powder is obtained as saleable carbon powder. Copper, cobalt, and nickel are obtained as pure cathodes through solvent extraction (SX) and electrowinning techniques (EW). Manganese is obtained as manganese dioxide powder during cobalt electrowinning. Finally, lithium remains in the solution as lithium sulphate and recovered as lithium carbonate.

In this process, copper, nickel, and cobalt are recovered as pure cathodes, having a purity of about 99.3-99.5%. These cathodes do not need any further processing or purification and are ready to be used. The process is safer than the existing processes as the pre-treatment carried out prior to leaching prevents frothing, which is a recognised safety hazard due to exothermic reactions. The process avoids cementation i.e., addition of contaminants like iron, for recovery of copper as cement copper. The process also accommodates a feed having manganese content as high as 10-20%, unlike the existing processes. In the conventional technologies, when the feed is rich in manganese content, while recovering manganese at a suitable pH, cobalt also gets co-precipitated at that pH, thereby requiring further purification.

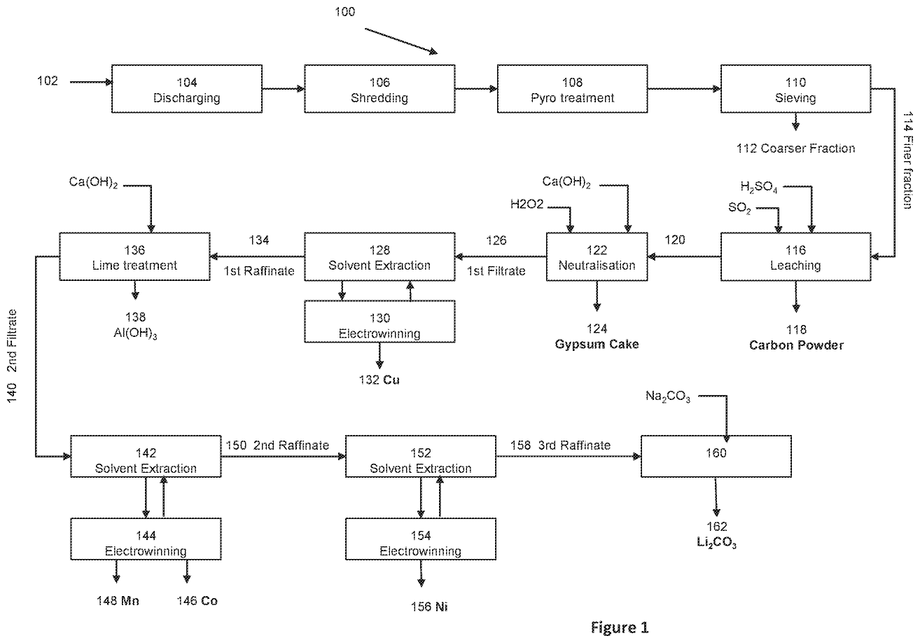

As shown in FIG. 1, the process 100 is for treating spent lithium ion batteries 102 to recover various metals. At step 104, the spent batteries 102 may be discharged followed by shredding at step 106. The discharged and shredded spent batteries may be roasted in a furnace, thus undergo a pyro treatment at step 108. The pyro treated material may be sieved at step 110 to separate a coarser fraction 112 and a finer fraction 114. The coarser fraction 112 may include aluminium and copper chips. The finer fraction 114 may be made into slurry with deionised water and may be leached at step 116 with sulphuric acid and sulphur dioxide. The leached slurry may be filtered to recover carbon powder 118 from the leach liquor 120. The leach liquor 120 may be subjected to neutralization at step 122. The neutralization may be carried out with calcium hydroxide and hydrogen peroxide. Neutralizing the leach liquor 120 with hydrated lime may produce a gypsum cake 124. The neutralized leach liquor may be filtered to separate the gypsum cake 124 from a first filtrate 126. The first filtrate 126 may be subjected to a solvent extraction at step 128 and an electrowinning at step 130 to obtain copper as a copper cathode 132 and a first raffinate 134. The first raffinate 134 may be treated with hydrated lime at step 136 to separate aluminium as hydroxide 138 and a second filtrate 140. The second filtrate 140 may further be subjected to a solvent extraction at step 142 and to an electrowinning at step 144 to obtain cobalt as a cobalt cathode 146, manganese as an anode mud 148 and a second raffinate 150. The second raffinate 150 may be subjected to a solvent extraction at step 152 and an electrowinning at step 154 to obtain nickel as a nickel cathode 156 and a third raffinate 158. The third raffinate 158 may be treated at step 160 with sodium carbonate to recover lithium as lithium carbonate 162.

In the process 100, the spent lithium ion batteries 102, obtained from different types of lithium ion spent batteries may be used as the feed material. The spent lithium ion batteries 102 may be discharged at step 104 by soaking in a sodium chloride (NaCl) solution. The discharged material may be shredded at step 106 by crushing using a shredder a size reducing step. Shredded battery material may be subjected to a pyro treatment at step 108 to burn off plastics and to get rid of any organic material. The plastics may be discarded. The rest of material may be fed to a furnace at step 108, at a temperature in a range of 300° C. to 800° C. for about 30 minutes to about 4 hours. In some embodiments, the material may be heated at a temperature of 500° C. for an hour. After sieving at step 110, using one deck screening, the coarser fraction, 112, including aluminium and copper chips may be separated manually and the finer fraction 114 containing cobalt, lithium, rest of copper, nickel, manganese, iron and rest of aluminium may further be processed. During the roasting process about 17% weight loss may be observed. About 40-43% by weight of aluminium and copper chips may be recovered while about 40% by weight of total battery weight may be recovered as the finer fraction. The finer fraction, a black powder, which is the feed material to the leaching process, contains more than 98% particles that pass through 325 mesh British Standard Sieve (BSS). The finer fraction may be leached in a single stage. The finer fraction may be mixed with the desired quantity of deionised water to make slurry having a target pulp density. In some embodiments, the pulp density may be in a range of about 5-25% solids (wt./vol). In some embodiments the pulp density may be about 10% (wt./vol). The slurry may be leached at step 116 with 1M-2M sulphuric acid along with sulphur dioxide and at a temperature of about 60-80° C. The required amount of sulphuric acid is added to achieve desired molarity and sulphur dioxide is sparged at the controlled rate to maintain slurry pH and Eh. The time for leaching is over a period of at least 6 hours whereby 97.0-99.5% of copper, nickel, cobalt, lithium, aluminium, manganese may be dissolved. The leaching conditions have been optimized based on a series of experiments carried out by varying parameters including time, temperature and sulphuric acid molarity and amount of sulphur dioxide.

On completion of leaching, the leached slurry may be filtered to recover carbon powder 118 from the leach slurry 120. The leach liquor 120 may be subjected to neutralization at step 122. The pH of leach liquor 120 may be adjusted to neutralize free acid and to remove traces of iron present in the leach liquor 120. The neutralization may be carried out with calcium hydroxide and hydrogen peroxide. Neutralizing the leach liquor 120 with hydrated lime may produce a gypsum cake 124, and the first filtrate 126. The first filtrate 126 may be subjected to a solvent extraction at step 128 and an electrowinning at step 130 to obtain copper as a copper cathode 132 and a first raffinate 134. Copper may be loaded using 10% Acorga M5640™ diluted in Exxsol D80 ™ as the extractant in multiple stage extraction and stripping, wherein the number of stages of extraction and stripping depends on concentration of metals in the spent lithium ion batteries. In one embodiment, copper may be extracted in two stage extraction and single stage stripping. The first raffinate 134 may be generated as an aqueous phase after copper loading by solvent extraction at step 128. The first raffinate 134 may be subjected to pH adjustment at step 136 to precipitate aluminium as hydroxide 138. The slurry may be filtered to obtain the second filtrate 140 which is used for cobalt recovery. The second filtrate 140 may further be subjected to a solvent extraction at step 142 and to an electrowinning at step 144 to obtain cobalt as cobalt cathode 146, manganese as an anode mud 148 and a second raffinate 150. Cobalt and manganese may be loaded using 40% Cyanex 272™ diluted in Exxsol D80™ in multiple stage extraction, scrubbing, and stripping, wherein number of stages of extraction, scrubbing and stripping depends on concentration of metals in the spent lithium ion batteries. In one embodiment four stage extraction, two stage scrubbing, and two stage stripping may be used to recover cobalt as cobalt cathode 146 having a purity of >99%. The second raffinate 150 may be subjected to a solvent extraction at step 152 and an electrowinning at step 154 to obtain nickel as a nickel cathode 156 and a third raffinate 158. Nickel may be loaded using 10% Versatic acid™ diluted in Exxsol D80™ in multiple stage extraction, scrubbing, and stripping, wherein number of stages of extraction, scrubbing and stripping depends on concentration of metals in the leach solution obtained after treating spent lithium ion batteries. In one embodiment, two stage extraction, single stage scrubbing, and single stage stripping may be used to extract nickel as nickel cathode 156 having a purity of 99.3 to 99.9%. The third raffinate 158 may be treated at step 160 with sodium carbonate to recover lithium as lithium carbonate 162.

Thus, according to the disclosure, copper, nickel, and cobalt may be recovered as pure cathodes. The residue cake obtained after leaching may contain 94.0-96.0% carbon as graphite. Manganese may be recovered as manganese dioxide as anode mud. The process may be applicable to all types of spent batteries and not specific to a single battery material. The process provides a complete flowsheet for complete extraction of metal values associated with spent lithium ion batteries.

The following example is intended as illustrative and non-limiting and represents specific embodiments of the present disclosure. The example shows a method to recover metals and carbon powder from spent lithium ion batteries.

### Example-1

The specific example for extraction of Cu, Ni, Co, Mn, Li, Co, and carbon is as follows:

The spent lithium ion batteries were discharged using sodium chloride. 1000 g material of mixed spent lithium ion batteries was subjected to shredding and followed by roasting at 500° C. for 1 h. Sieving was carried out to separate the coarse material and fine black powder. Weight loss during this step was 166 g. Weight of Cu and Al chips was 430 g. Rest of black powder was 404 g. as shown in Table 1.

TABLE 1
Weight wise distribution after
Roasting and Screening

| Description | (g) | (%) |
|---|---|---|
| Spent Battery | 1000.0 | 100.0% |
| Loss during Roasting | 166.0 | 16.6% |
| Al-Cu Chips | 429.9 | 43.0% |
| Black Powder | 404.1 | 40.4% |

The black powder was ground and sieved to pass through 325 mesh BSS to get more than 98% powder passing through 325 mesh. 50 g of sieved black powder was taken for carrying out leaching. Chemical analysis of the black powder was presented in Table 2.

TABLE 2
Chemical Analysis of Black Powder (wt. %)

| Cu | Ni | Co | Mn | A | Li | Fe | C |
|---|---|---|---|---|---|---|---|
| 4.01 | 2.71 | 22.94 | 10.82 | 6.02 | 3.42 | 0.32 | 26.8 |

The sieved black powder was made of desired pulp density of 10% (wt./v) using process water and addition of concentrated sulphuric acid so as to obtain acid molarity of 1M and adding sulphur dioxide for a period of first three hours of leaching (total 40 g SO₂). Leaching was carried out at a temperature of 80° C. for a period of 6 hours. The composition of leach liquor is given in Table 3 and the corresponding recovery of metals is given in Table 4.

TABLE 3
Leach Liquor Composition (g/L)

| Cu | Ni | Co | Mn | Al | Li | Fe |
|---|---|---|---|---|---|---|
| 4.0 | 2.70 | 22.45 | 10.80 | 5.99 | 3.40 | 0.252 |

The leached slurry was filtered for solid liquid separation and washing cycles were carried out to wash out the dissolved metal values from the solid cake. More than 99% Cu, Ni, Li, Mn were leached as shown in Table 4. Cobalt recovery is 97.8%.

TABLE 4
Metal Recoveries during Leaching (%)

| Cu | Ni | Co | Mn | Li |
|---|---|---|---|---|
| 99.7 | 99.6 | 97.8 | 99.8 | 99.4 |

Three batches of 100 g each were leached under identical conditions as mentioned above and the leach liquors were combined for downstream processing. The leach liquor obtained was taken for acid neutralization with lime slurry and filtered to obtain the first filtrate. The first filtrate 1 was treated for copper separation by solvent extraction-electrowinning to get pure copper cathode. The solvent extraction-electrowinning (SX-EW) for copper was carried out using 10% Acorga M5640™ diluted in Exxsol D80™ in 2 stages of extraction and single stage stripping. Copper recovery in solvent extraction-electrowinning was 99.0%. The first raffinate was generated after copper loading. The pH of the first raffinate was raised to 5.5 with hydrated lime wherein aluminium and traces of copper present were precipitated as hydroxide. The slurry was filtered to obtain copper, aluminium free second filtrate. Cobalt and manganese were loaded onto 40% Cyanex 272™ diluted in Exxsol D80™ from the second filtrate. Four extractions, two scrubbing and two stripping stages were used in cobalt solvent extraction. Cobalt was recovered as cathode by solvent extraction-electrowinning from the second filtrate 2 and recovery is 99.0%. Manganese was recovered as anode mud during cobalt solvent extraction-electrowinning. After cobalt loading, the second raffinate was generated.

Second raffinate was treated for nickel extraction by 10% Versatic acid™ diluted in Exxsol D80™ in 2 extraction stages, 1 scrubbing stage and 1 stripping stage. 99.0% recovery of Ni was obtained during SX-EW. Ni loading from the second raffinate generated the third raffinate. The third raffinate was treated for lithium recovery as lithium carbonate by treating with sodium carbonate. The residue obtained after leaching was washed and dried to obtain carbon in a saleable form. The overall recoveries of all the metals were 95.0-98.0%.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A process for treating spent lithium ion batteries to recover metals, the process comprising:
discharging the spent lithium ion batteries;
shredding the discharged lithium ion batteries;
roasting the shredded lithium ion batteries in a furnace to produce roasted material;
sieving the roasted material to separate a coarser fraction and a finer fraction, wherein the coarser fraction comprises aluminum chips and copper chips;
making a slurry of the finer fraction with de-ionized water;
leaching the slurry with sulphuric acid and sulphur dioxide;
filtering the leached slurry to separate carbon powder from leach liquor;
neutralizing the leach liquor with hydrated lime to produce a gypsum cake;
filtering the neutralized leach liquor to separate the gypsum cake from a first filtrate;
subjecting the first filtrate to solvent extraction and electrowinning to obtain copper as a copper cathode and a first raffinate;
treating the first raffinate with hydrated lime to obtain aluminium as aluminium hydroxide and a second filtrate;
subjecting the second filtrate to solvent extraction and electrowinning to obtain cobalt as a cobalt cathode, manganese as an anode mud and a second raffinate;
subjecting the second raffinate to solvent extraction and electrowinning to obtain nickel as a nickel cathode and a third raffinate; and
treating the third raffinate with sodium carbonate to recover lithium as lithium carbonate.

2. The process as claimed in claim 1 produces zero solid waste.

3. The process as claimed in claim 1, wherein the spent lithium ion batteries comprise Lithium Cobalt Oxide (LCO) batteries, Nickel Manganese Cobalt Oxide (NMC) batteries, or Nickel Cobalt Aluminum oxide batteries (NCA) obtained from mobile phones, laptops, electronic goods and electric vehicles.

4. The process as claimed in claim 1, wherein treating spent lithium ion batteries to recover metals comprises sequentially recovering copper, cobalt, and nickel with a purity of 99.3 to 99.9% and manganese as manganese dioxide and lithium as lithium carbonate.

5. The process as claimed in claim 1, wherein the carbon powder contains 94.0-96.0% carbon as graphite and is a saleable commodity.

6. The process as claimed in claim 1, wherein roasting the shredded lithium ion batteries in a furnace comprises heating at a temperature in a range of 300° C. to 800° C. for about 30 minutes to about 4 hours.

7. The process as claimed in claim 1, wherein making slurry of the finer fraction with water comprises making the slurry having a pulp density in a range of 5 to 25% (wt./v).

8. The process as claimed in claim 1, wherein subjecting the first filtrate to copper solvent extraction and electrowinning comprises using 10% Acorga M5640™ diluted in Exxsol D80™ in multiple stage extraction and stripping, wherein number of stages of extraction and stripping depends on concentration of metals in the leach liquor which in turn depends on % copper present in spent lithium ion batteries.

9. The process as claimed in claim 1, wherein subjecting the second filtrate to cobalt solvent extraction and electrowinning comprises using 40% Cyanex 272™ diluted in Exxsol D80™ in multiple stage extraction, scrubbing and stripping, wherein number of stages of extraction, scrubbing and stripping depends on concentration of metals in the leach liquor which in turn depends on % cobalt and manganese present in spent lithium ion batteries.

10. The process as claimed in claim 1, wherein subjecting the second raffinate to solvent extraction and electrowinning comprises using 10% Versatic™ acid diluted in Exxsol D80™ in multiple stage extraction, scrubbing and stripping, wherein number of stages of extraction, scrubbing and stripping depends on concentration of metals in the leach liquor which in turn depends on % nickel present in spent lithium ion batteries.
